(19) United States
(12) Patent Application Publication
(10) Pub. No.: US 2004/0047490 A1
(43) Pub. Date: Mar. 11, 2004

(54) Visibly altering a product in response to invalidating event

(76) Inventors: Tyler J. McKinley, West Linn, OR (US); Eric C. Hudson, Pinole, CA (US)

Correspondence Address: DIGIMARC CORPORATION, 19801 SW 72ND AVENUE, SUITE 100, TUALATIN, OR, 97062, US

(21) Appl. No.: 10/394,507

(22) Filed: Mar. 21, 2003

Related U.S. Application Data
(60) Provisional application No. 60/367,033, filed on Mar. 22, 2002.

(51) Int. Cl. G06K 9/00

(52) U.S. Cl. 382/100

(57) ABSTRACT

This disclosure describes methods and systems for visibly altering a security card in response to detecting a change in access permission, such as an event that invalidates the card. In one implementation, a machine-readable code on the card carries an index to a database of access permission information. A reader extracts the code from the card when its bearer presents it for validation. The reader looks up the access permission and either permits access, denies access, or invalidates the card. One mode for invalidating the card visibly alters the card so that other personnel can identify the card as being invalid through visible inspection.

### TECHNICAL FIELD

The invention relates to security cards, and methods for altering security cards to invalidate them to prevent fraud and misuse.

### BACKGROUND AND SUMMARY

Security cards are widely used to control access to facilities, computer systems, etc. One challenge is developing schemes to manage whether a particular card is valid. One such scenario arises when the bearer of the card is no longer granted access to a particular facility or device. In these circumstances, the system managing access needs to differentiate cards that are no longer valid. Automated identification card systems have the capability to deactivate a particular ID card. However, often this is insufficient to guard against improper access because the card itself, though invalid, appears unchanged. As such, other personnel cannot distinguish valid from invalid cards from mere visible inspection.

There are a number of card features that can be used to monitor the status of a particular security card. One such feature is a digital watermark. The digital watermark provides a mechanism to carry a machine-readable code bearing an identification number. The level of access associated with this identification number may be stored in a database and checked at points of access to allow or prevent access. Other machine-readable features may perform this function as well.

Digital watermarking is a process for modifying physical or electronic media to embed a hidden machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by subtly altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending application Ser. No. 09/503,881 and U.S. Pat. No. 6,122,403, which are hereby incorporated by reference.

This disclosure describes methods and systems for visibly altering a security card in response to detecting a change in access permission, such as an event that invalidates the card. In one implementation, a machine-readable code on the card carries an index to a database of access permission information. A reader extracts the code from the card when its bearer presents it for validation. The reader looks up the access permission and either permits access, denies access, or invalidates the card. One mode for invalidating the card visibly alters the card so that other personnel can identify the card as being invalid through visible inspection.

In one implementation, the machine-readable code comprises a digital watermark embedded on the card. The digital watermark is embedded in an image printed on the card. The reader is a digital watermark reader that reads a message payload from the digital watermark and looks up a code extricated from this payload in an access permission database. In response to detecting that the permission rights are terminated for the bearer of the card, the reader visibly alters the card. The disclosure describes several methods and card structures that enable the reader to effectively alter the card's visible appearance.

Further features will become apparent with reference to the following detailed description.

### BRIEF DESCRIPTION OF THE DRAWINGS

FIG. 1 is a diagram illustrating a system for access control with the capability to check access card validity and visibly alter invalid access cards.

FIG. 2 is a flow diagram illustrating a process for checking card validity and altering invalid cards.

FIG. 3 is a flow diagram illustrating a process for capturing surveillance video associated with an access event.

FIG. 4 is a flow diagram illustrating a process for applying a digital watermark to an object for controlling object handling.

### DETAILED DESCRIPTION

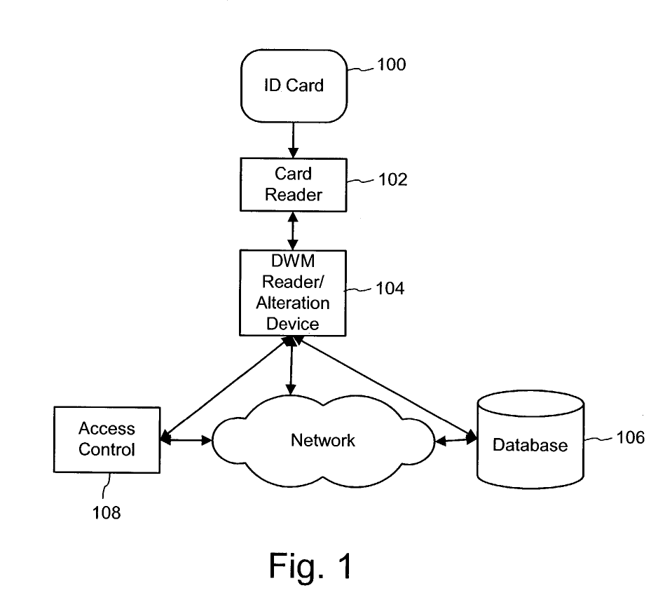

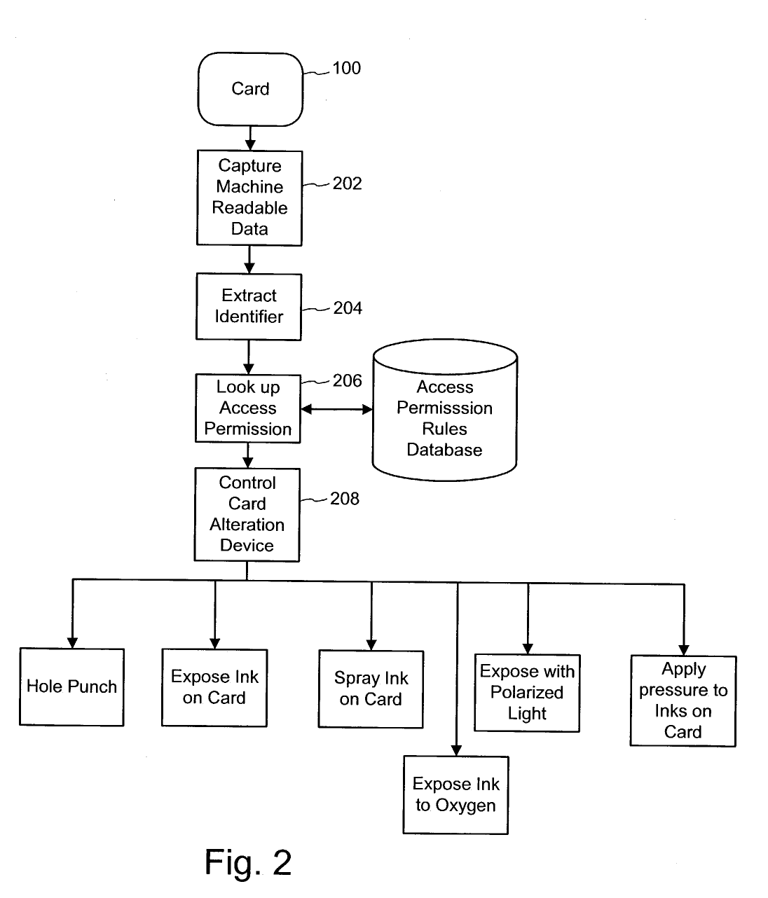

To illustrate our access control system, we use the example of an ID access card system used to control employee access to a secure facility. FIG. 1 is a diagram illustrating a system for access control with the capability to check access card validity and visibly alter invalid access cards. FIG. 2 is a flow diagram illustrating a process for checking card validity and altering invalid cards.

In one scenario, an employee's card 100 is invalidated when he's terminated, yet the employee retains the card (or it falls in someone else's hands). To get access to the facility, the bearer of the card 100 shows the card to the reader 102 as shown in block 202. In response, the reader 102 extracts a digital watermark payload from a digital image scanned from the card (e.g., a camera or other image sensor captures an image and presents it to a digital watermark reader)(see block 204 in FIG. 2, for example). The reader looks up an identification number extracted from the digital watermark in a database 106 as shown in block 206. The database controls facility access and is updated to provide levels of access for each identification number. In some locations, the reader automatically controls doors (e.g., electronically controls an automatic door latch) and/or controls access to computer systems and files stored on these systems (as reflected in block 106). The reader only allows access when the database look-up returns a level of access permission that is at or above the level of access required for the particular access point of the reader. In other locations, there is no reader present, and the facility relies on other security measures, such as surveillance cameras, security personnel patrols, etc.

When an employee is terminated, or otherwise changes in level of access permission, the database entry associated with that employee's identification number is updated accordingly with the appropriate access permission (e.g., no access in the case of termination).

Due to the nature of the facility, it is not possible to prevent all access to all locations within the facility. For example, the facility may be an airport spread over a large area with portions that are less secure. As such, it is possible for card bearers to gain access to the facility in some places without showing the card to a reader.

To limit the extent to which an employee can gain access to the facility, the reader includes an additional alteration device 104 that visibly alters the card in response to detecting a change in access permission as shown in block 208 in FIG. 2. Below, we describe several embodiments of the alteration device, which are also illustrated in the blocks below 208 in FIG. 2.

In one embodiment, the reader includes a knife or multiple-hole punch that stamps the card upon receiving a destroy command from the reader. The database returns the destroy command in response to finding that the access permission has been changed to “no access.” Of course, there are multiple different rules for triggering the destroy command, such as multiple attempts to gain access to a facility area or system where the employee does not have the appropriate level of access permission.

In another embodiment, every card is pre-printed with un-developed ink that is transparent in the visible spectrum but turns opaque when a specific narrow spectrum band of light not commonly found is shined on it. After the ink is exposed it turns opaque in the color of that ink (e.g., gray, brown, green, etc.). The reader instructs the bulb (which generates this narrow band of light from the spectrum) inside the mechanism to flash—this exposes the ink and proceeds to “develop” or turn opaque, hiding the rest of the card. Because of the change in color, the card appears to be obviously invalid from a visual inspection from fifteen or twenty feet away.

In another embodiment, a vial of highly visible ink, such as that used on roadways to mark hazards, is shot out under pressure in response to the destroy command. This process slathers the card in such a way to make it appear obviously invalid from a distance.

In another embodiment, the card is originally made to carry an ink or solution that develops under visible light, but a laminate applied to the card surface is polarized to protect it. The reader flashes a bulb with a polarizer filter on it that polarizes light emitted from the bulb so that the light passes through the polarized surface of the card and exposes the ink. The reader may also expose the ink by applying spikes or punching holes that perforate the laminate and enable the light from the bulb to expose the ink.

In another embodiment, the reader activates a roller that uses pressure to press inks together, which then turn opaque under that pressure.

In another embodiment, the card is pre-printed with ink that is invisible in normal conditions when not exposed to oxygen. A laminate or other protective surface layer is applied over the ink layer in a vacuum chamber or nitrogen tank for example, over the ink which is sealed under the laminate. When exposed to oxygen, the ink develops and turns opaque. The reader activates a roller that is covered with spikes. In response to the destroy command, the roller goes over the card, pricking holes in the laminate and exposing the ink to oxygen. The ink then turns opaque or another color.

This functionality can be extended to the triggering of video data capture before and after the unauthorized watermark is detected. As noted before, embedded watermarks can control access to files, facilities and computer etc. Because digital watermarks can be detected by an image capture device—a webcam, a digital camera, CCD's & CMOS sensors for example—the environment in which the watermark exists can also be captured particularly for auditing or security purposes.

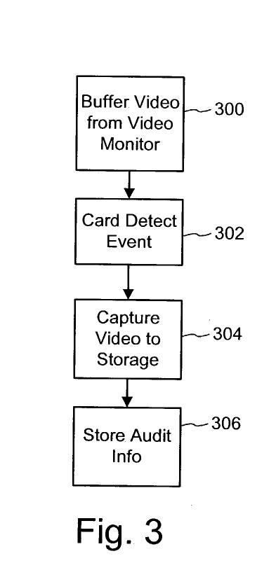

FIG. 3 is a flow diagram illustrating a process for capturing surveillance video associated with an access event. In one embodiment of this method, the reader includes a webcam to capture an image of the card and to monitor those attempting to gain access to a building. A computer controlling the camera constantly buffers ten seconds (or some other predetermined amount of video) in memory as shown in block 300. The computer can, alternatively, capture and store video continuously. However, this embodiment is designed for applications where there is limited persistent storage for video. While the computer is buffering ten seconds of video at any one time, the unauthorized employee presents the invalid card to the camera as shown in block 302. Not only does this presentation elicit the “destroy card” function, it also instructs the computer to save the ten seconds (or other arbitrary amount of time) of video and immediately begin capturing the next ten seconds of video (or arbitrary amount of time) as shown in block 304. This enables the computer to maintain an audit trail in video of who has tried to access the facility, lab, hard drive, computer, etc. Not only is the video data recorded, but the payload of the watermark is recorded as well as shown in block 306. This would also expose which digital watermark the person attempted to use to gain access the facility.

A microphone could also be attached to the camera capturing audio data in the same manner as the video is captured in this example.

Additionally, if this embodiment were used at an airport for example, multiple imaging devices could be triggered if the wrong mark were presented. Pan chromatic, x-ray multi-spectral, etc. type of imaging devices could be activated if a suspect watermark were presented.

The capture of video can also be triggered by a valid card, not just an invalid card.

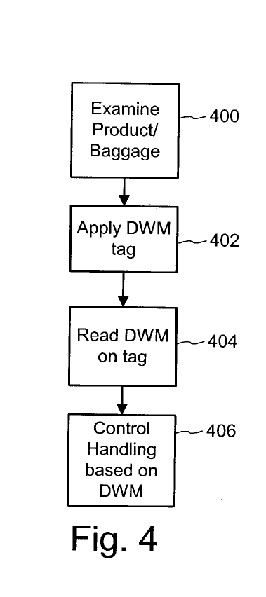

FIG. 4 is a flow diagram illustrating a process for applying a digital watermark to an object for controlling object handling. An additional embodiment of this example is in an airport baggage handling system. Because baggage-handling systems are typically overwhelmed with traffic, random samples of bags are typically searched instead of every bag to complete an exhaustive search for nefarious contents. To improve the successful monitoring of bags, this watermarking system could be implemented in an automated baggage handling setting. Here each bag would travel along a conveyer belt and go through a ‘first look’ device—this could typically be x-ray for example (e.g., block 400 in FIG. 4). If a bag were flagged for further inspection a watermarked tag could be stamped onto the bag as it travels as shown in block 402. The bag could be stamped with notification that it needs to be checked for stronger x-ray or for explosives monitoring. Along the conveyer belt an “exit ramp” would be placed that holds the additional monitoring device. If the watermarked tag contained the “explosives station” the bag would be diverted to that station as shown in block 404 and 406. Upon completion of the inspection the machine would take the appropriate action. If it were deemed not clear, the machine would dump it to a containment room or room for human inspection. If it was deemed clear, the bag would go along the general belt to its destination unless the original ‘first look’ device tagged it with two marks intending for stops at additional monitoring stations. If at anytime the determination was that nothing were found in the bag to warrant further action, the bag would automatically be dumped back onto the general ramp for loading.

As noted above, the destroy command may be triggered by any number of programmable rules in the reader. In some circumstances, it is useful to be able to make a decision regarding the validity of a card without resorting to a database. One such case is where the information on the card indicates that the card has been altered. One indicator of an invalid card is where information on one part of the card does not relate correctly to other information on the card. For example, information from one machine-readable feature does not match information from another machine-readable feature on the card. In this case, the reader includes a decoder for each such feature, which automatically reads the feature. The reader includes a processor for comparing information from the various features to determine authenticity. These features may include bar codes, digital watermarks, text readable by optical character recognition, magnetic stripes, magnetic inks, radio frequency tags, etc.

Another example is where a particular security feature, such as a digital watermark, has changed in a manner that indicates that the card is not authentic. In the case of the digital watermark, the reader evaluates the degradation of the digital watermark signal to analyze whether the card is authentic.

The above system can be readily adapted for inspection of other types of products. It is particularly well suited for monitoring product in manufacturing, inventory control, or distribution applications. In such an application, the reader includes a camera (e.g., CCD or CMOS imaging device) that captures images of product as it moves by the camera. If the product is invalid, the reader applies a stamp or sticker on the invalid product. The stamp or sticker may include information indicating why the product is invalid or include a machine-readable code, such as a digital watermark, that controls further machine actions on the product (e.g., routing to an inspection facility).

The product may be determined to be invalid because it bears a machine-readable code that is not valid for a particular time or location of the inspection. For example, the digital watermark on the product bears an identification number that is not within a range of valid products for a particular time or location. Alternatively, the product may be determined to be invalid because information derived from the product (including its packaging) indicates that it is not authentic. Above, we listed examples of approaches for determining authenticity, including: 1. Looking up an identifier extracted from the object in a database; 2. Comparing information from different locations or features on the product to determine whether the information matches (or matches information in an external database entry associated with an identifier on the object; and 3. Measuring the degradation of a security feature like a digital watermark to determine whether the product (or its packaging) has been illegally reproduced to make a counterfeit. All of these approaches may be used to generate an invalidating event, causing the reader to visibly alter the product and/or add a machine-readable code (e.g., print a digitally watermarked image or apply a digitally watermarked sticker) to the product to control further handling of it.

Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the digital watermark encoding processes may be implemented in a programmable computer or a special purpose digital circuit. Similarly, the digital watermark reader may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

We claim:

1. A system for visibly altering a security card comprising:
a reader for extracting information from a machine readable code on the card and using the information to determine whether the card is valid; and
an alteration device in communication with the reader for visibly altering the card in response to determining that the card is not valid.

2. The system of claim 1 wherein the reader comprises a digital watermark reader.

3. The system of claim 2 wherein the digital watermark reader extracts an identifier from a digital watermark embedded in an image scanned from the card, and the identifier is used to look up access permission information indicating whether the card is valid.

4. The system of claim 1 wherein the alteration device comprises a light source that exposes a coating on the card, changing color of the card.

5. The system of claim 4 wherein the light source emits light solely in a particular spectral band to expose the coating on the card.

6. The system of claim 1 wherein the alteration device includes a perforating device for perforating the card.

7. The system of claim 6 wherein the perforating devices is operable to perforate a polarized layer on the card, enabling light to pass through perforations in the polarized layer and expose a coating underneath the polarized layer on the card.

8. The system of claim 6 wherein the perforating device is operable to perforate a layer, exposing a coating sealed under the layer to ambient air and causing the coating to change color.

9. A system for visibly altering a product during automated inspection of the product, the system comprising:
a reader for extracting information from a machine readable code on the product and using the information to determine whether the card is valid; and
an alteration device in communication with the reader for visibly altering the product in response to determining that the product is not valid, the alteration device operable to apply a stamp or sticker to a surface of the product in response to determining that the product is not valid.

10. The system of claim 9 wherein the machine readable code comprises a digital watermark embedded on a surface of the product.

11. The system of claim 9 wherein the stamp or sticker carries a digital watermark with a message payload.

12. The system of claim 11 wherein the message payload is includes information used to control handling of the product.

13. A system for inspecting an object comprising:
a reader for extracting information from a digital watermark on the object and using the information to determine whether the object is valid;
the reader including a camera for capturing digital video of the object and surrounding objects, a digital watermark decoder for extracting the digital watermark from the video, memory for buffering a predetermined amount of most recently received surveillance video from the camera, and persistent storage for storing surveillance video captured in the buffer in response to detection of an event by the reader.
